(19) United States
(12) Patent Application Publication
(10) Pub. No.: US 2007/0256072 A1
(43) Pub. Date: Nov. 1, 2007

(54) Multi-installer product deployment

(75) Inventors: Paul C. Barr, Redmond, WA (US); Jeffrey M. James, Kirkland, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/415,329

(22) Filed: May 1, 2006

(51) Int. Cl. G06F 9/445

(52) U.S. Cl. 717/174

(57) ABSTRACT

A custom action associated with a core installer leverages privileges of the core installer to access satellite installers. The custom action includes code for identifying that a software product includes multiple installers and that the core installer has been cached. The custom action determines the product source. Identified satellite installers are associated with the client device. Pre-generated scripts of the satellite installers are accessed and the scripts are applied to the client to facilitate satellite installer advertisement/assignment. In this manner, the custom action associated with the core installer leverages the privileges of the core installer to install satellite installers on a lockdown client device. The custom action allows multi-installer software products to be installed on a client via a software deployment technology configured for single installer software products. As such, multi-installer software products may be easily deployed and installed on client devices.

### BACKGROUND

Many small to medium sized business organizations have a network infrastructure to allow software product distribution by a network administrator. A client user on the network may have rights to use programs on the client but not have rights to install programs on the client. Software products may be installed on the client by the network administrator by manually installing the program on each client. Such installation is very time consuming and tedious. A network administrator may also use a software deployment technology to advertise available software for download to a client. Such deployment comes from a central server and is less time consuming than manual installation because software products may be advertised to a plurality of clients at one time.

Several software products include a single product installer for facilitating the installation of the software product on a client via a software deployment technology. In such a situation, the single product installer bundles both the application binaries and application specific resources. Also, many software deployment technologies may only deploy a single product installer to a client during software distribution.

Software products may also be programmed with multiple product installers. In such a situation, one product installer may include the application binaries and multiple other installers may include the application specific resources. In the past, software deployment technologies that can only deploy a single product installer cannot facilitate installation of software products that are programmed with multiple product installers.

### SUMMARY

This Summary is provided to introduce a selection of concepts in a simplified form that are further described below in the Detailed Description. This Summary is not intended to identify key and/or essential features of the claimed subject matter. Also, this Summary is not intended to limit the scope of the claimed subject matter.

A custom action is associated with a core installer to leverage the privileges of the core installer to install satellite installers on a lockdown client device. The custom action allows multi-installer software products to be installed on a client via a software deployment technology configured for single installer software products. In this manner, multi-installer software products may be easily deployed and installed on client devices.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates an exemplary computing device;

FIG. 2 represents one exemplary environment for deploying a software product in a network;

FIG. 3 represents one exemplary system overview for installing a multi-installer product;

FIG. 4 represents an operational flow diagram for installing a multi-installer product; and

FIG. 5 represents an operational flow diagram for executing a custom action.

### DETAILED DESCRIPTION

Embodiments are described more fully below with reference to the accompanying drawings, which form a part hereof, and which show specific exemplary embodiments. However, embodiments may be implemented in many different forms and should not be construed as limited to the embodiments set forth herein; rather, these embodiments are provided so that this disclosure will be thorough and complete, and will fully convey the scope. Embodiments may be practiced as methods, systems or devices. Accordingly, embodiments may take the form of an entirely hardware implementation, an entirely software implementation or an implementation combining software and hardware aspects. The following detailed description is, therefore, not to be taken in a limiting sense.

The logical operations of the various embodiments are implemented (1) as a sequence of computer implemented steps running on a computing system and/or (2) as interconnected machine modules within the computing system. The implementation is a matter of choice dependent on the performance requirements of the computing system implementing the invention. Accordingly, the logical operations making up the embodiments described herein are referred to alternatively as operations, steps or modules.

In a small to medium sized business organization, software products are installed on client machines in many different ways. When a user has administrative rights to a client device, the user may download software products from the Internet or install a software product from a computer readable medium. Such rights are rarely issued to a user in a typical business setting because the business organization desires maintaining control over the software that the user has on the client device. For these reasons, many business organizations have restricted privileges on client devices. These restricted privileges may prohibit installation of software products.

In such situations, a network administrator may have the responsibility of maintaining and installing software on client devices. To install software products on a client device, the network administrator may be required to manually install the software on each client device. The network administrator logs onto the client device with heightened privileges. The network administrator may then install the software product onto the client device. Installing software products in this manner may be acceptable in business organizations with a small number of client devices. However, as the number of client devices increase, so does the time and labor required to install software products on each of the client devices.

When a network administrator desires installing a software product on several devices, the network structure of the business organization may allow the network administrator to utilize a software deployment technology to remotely install software on the client devices. A software deployment technology may facilitate the installation of a software product having a single installer. A single installer software product is a software product that includes both the application binaries and the application specific resources bundled into a single installer. The software deployment technology advertises the single installer of the software product on the client device. When an install action is instigated, the software product is installed on the client device.

Some software products may also include multiple installers. In such a situation, the software product may include a core installer that is associated with the application binary. The software may also include multiple satellite installers that are associated with application resources. Multi-installer software products may present problems for software deployment technologies that are configured to only install software products that have a single installer, because such software deployment technologies only recognize one installer.

A properly configured custom action allows a software product with multiple installers to be installed using such a software deployment technology. A custom action is associated with the core installer of the software product. The software deployment technology advertises the core installer on the client device. When an install action is instigated, the custom action associated with the core installer is executed. The source of the core installer is identified and the source is scanned to determine whether satellite installers are associated with the software product. If satellite installers are associated with the product, the custom action accesses script associated with the satellite installers and advertises the satellite installers on the client for facilitating installation.

Succinctly stated, the custom action associated with the core installer leverages the privileges of the core installer to install satellite installers on a lockdown client device. The custom action allows multi-installer software products to be installed on a client via a software deployment technology configured for single installer software products. In this manner, multi-installer software products may be easily deployed and installed on client devices.

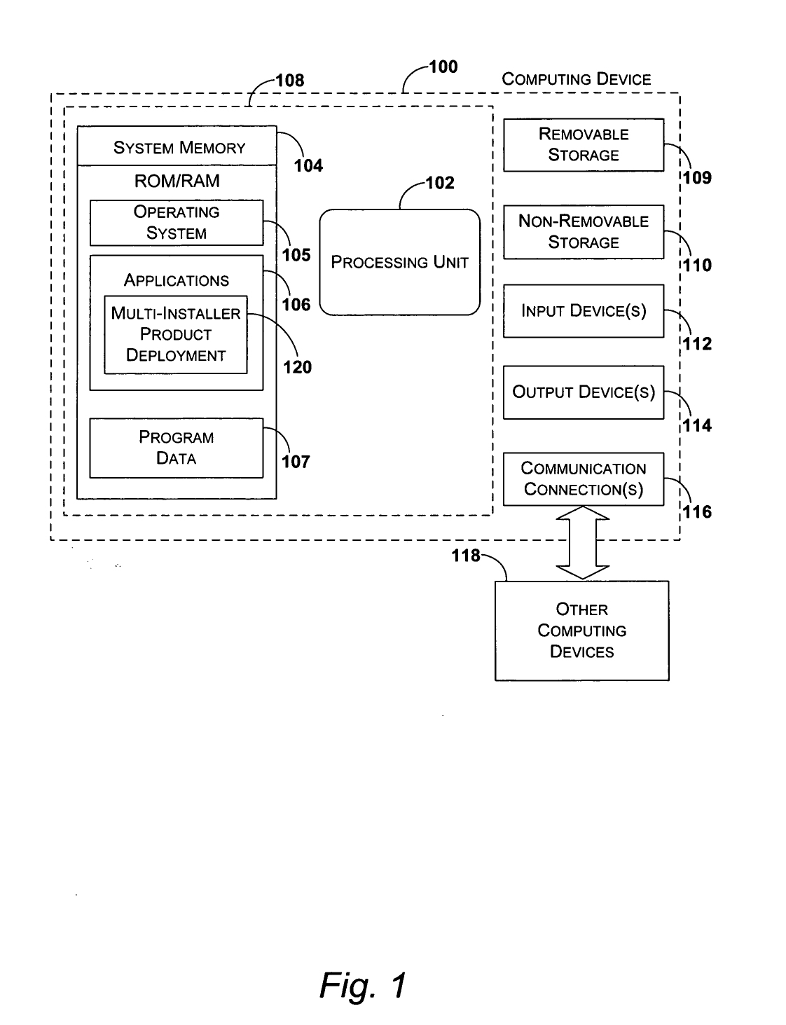

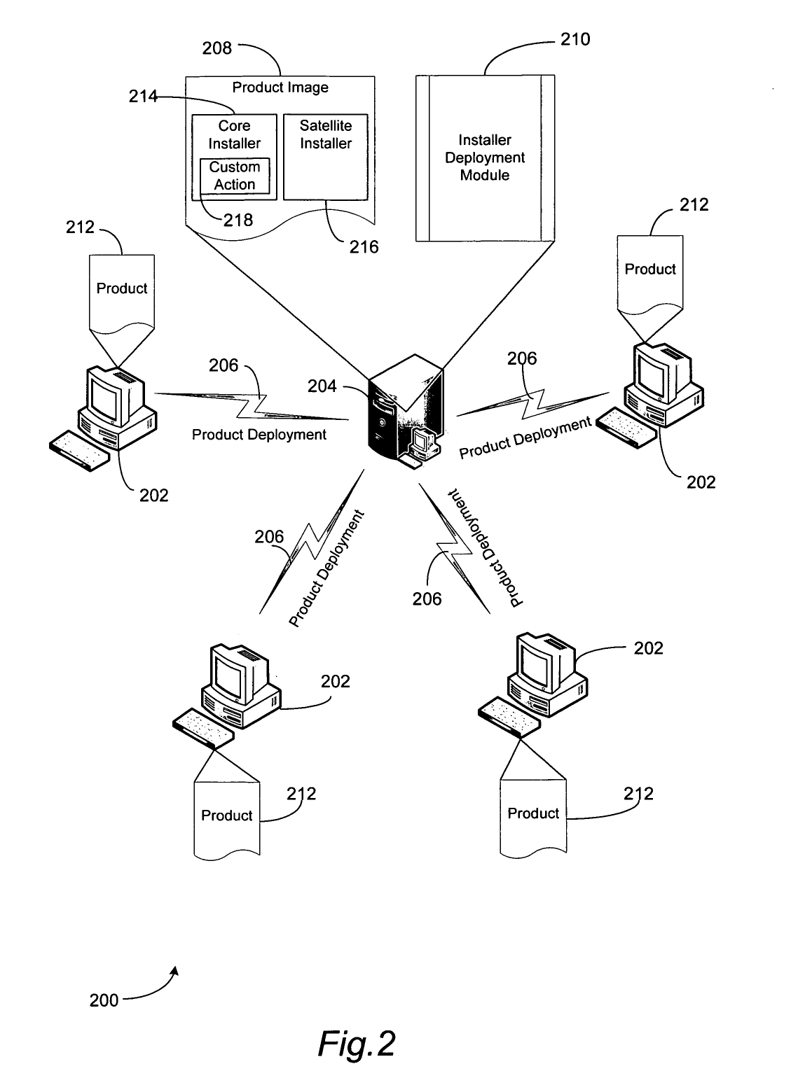

FIG. 2 represents one exemplary environment for deploying a multi-installer software product in a network. System 200 represents a modular overview of a computing environment. System 200 may include computing device 202. Computing device 202 may include a desktop computing device, mobile computing device, a laptop, a personal digital assistant, a notebook computer, and/or any other type of computing device functional to store data. In one aspect, computing device 202 includes computing device 100 as exemplified in FIG. 1.

System 200 also includes server 204. Server 204 may be associated with an administrator terminal. Server 204 may include any type of server that facilitates product deployment in a networked environment. Server 204 is in communication with computing device 202 via network connection 206. Network connection 206 may include a hardwired network connection and/or a wireless network connection. Network connection 206 may include any type of network connection functional to transmit data between a computing device and a server. Network connection 206 includes any type of network connection that facilitates product deployment.

In the distributed environment, server 204 may include product image 208 and installer deployment module 210. For example, an administrator may associate product image 208 with server 204 to facilitate product deployment to client 202. Client 202 may install product 212 on client 202.

In one embodiment, product 212 is a multi-installer product, such as, a “MICROSOFT OFFICE” product of MICROSOFT CORPORATION headquartered in Redmond, Wash. In such a situation, product image 208 includes core installer 214 and satellite installer(s) 216. In another embodiment, installer deployment module 210 is a single installer deployment module, such as, “MICROSOFT ACTIVE DIRECTORY” of MICROSOFT CORPORATION headquartered in Redmond, Washington. Core installer 214 may include custom action 218. Core installer 214 is deployed by installer deployment module 210 during product deployment to client 202. Custom action 218 leverages the privileges of core installer 214 to install satellite installer(s) 216 when client 202 is in a lockdown mode.

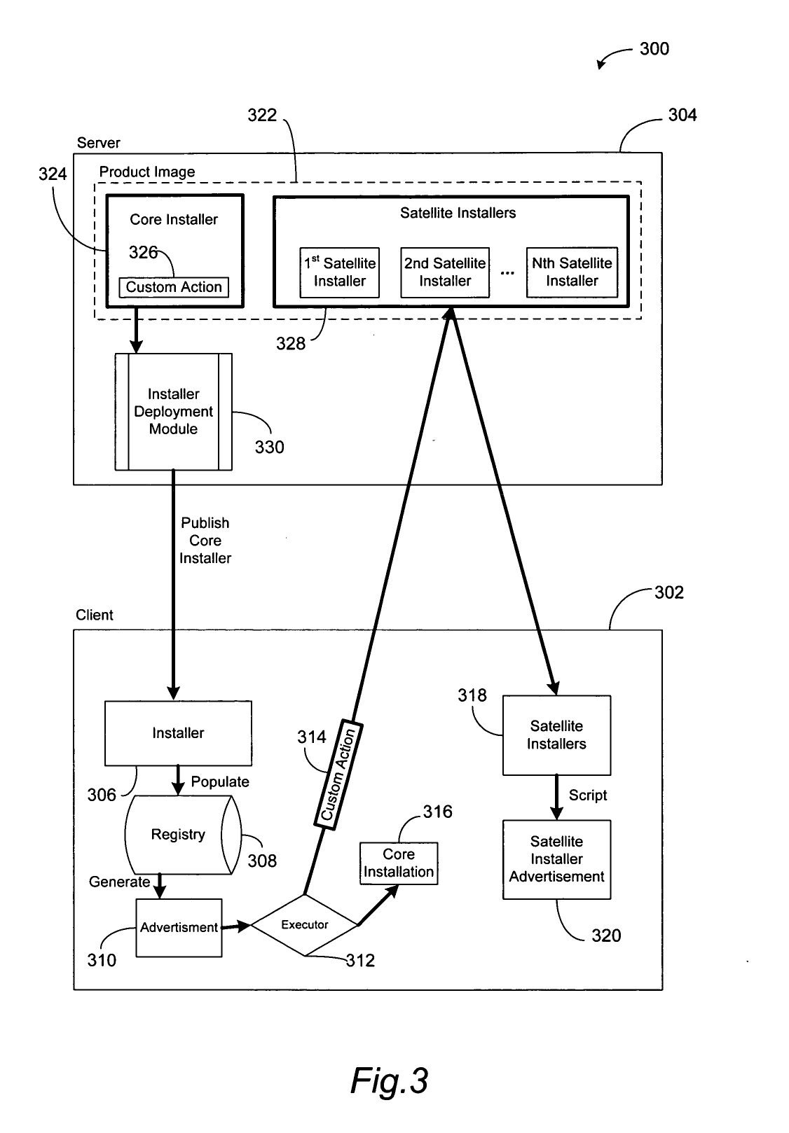

FIG. 3 represents one exemplary system overview for installing a multi-installer product. System 300 represents a modular overview of client 302 and server 304. System 300 may be integrated as a combination of software and hardware elements, an operating system or any combination thereof. Hardware, databases, software, applications, and/or programs referenced herein may be integrated as a single element or include various elements in communication with one another. Software and/or hardware elements are depicted herein for explanatory purposes only and not for limiting the configuration to multiple elements or a single element performing several functions unless specifically specified herein. For example, as depicted in FIG. 3, system 300 includes client 302 having installer 306, registry 308, advertisement 310, executor 312, custom action 314, core installation 316, satellite installers 318, and satellite installer advertisement 320. Reference numbers 306-320 may include separate programs, separate databases and separate hardware. Reference numbers 306-320 may also include a single program or any combination of single and multiple programs. Similarly, system 300 includes server 304 having product image 322, core installer 324, custom action 326, satellite installers 328, and installer deployment module 330. Reference numbers 322-330 may include separate programs, separate databases and separate hardware. Reference numbers 322-330 may also include a single program or any combination of single and multiple programs.

Server 304 may be associated with product image 322. Product image 322 is a product image for a multi-installer product. Product image 322 includes core installer 324 and satellite installers 328. Core installer 324 includes the binary application bits for the product. For example, if product image 322 is a product image for “MICROSOFT OFFICE”, core installer 324 may include the binary bits for “MICROSOFT WORD”, “MICROSOFT EXCEL”, “MICROSOFT OUTLOOK”, “MICROSOFT POWERPOINT”, and/or “MICROSOFT ACCESS.” Core installer 324 also includes custom action 326. As is more fully set forth below, custom action 326 leverages privileges of core installer 324 to facilitate the installation of satellite installers 328 on client 302.

Product image 322 also includes satellite installers 328. Satellite installers 328 may include any number of installers. In one aspect, satellite installers 328 include resource installers associated with core installer 324. Resource installers may include language resources, language resources from proofing, and/or any other type of resource associated with a language or geographic area. Satellite installers may pregenerate advertised scripts embedded therein. Core installer 324 and satellite installers 328 are separate installers that are associated with product image 322.

Installer deployment module 330 is a single installer deployment module. In one aspect, installer deployment module 330 includes MICROSOFT ACTIVE DIRECTORY. Installer Deployment module 330 publishes/assigns core installer 324 on client 302. To publish/assign core installer 324, installer deployment module 330 may generate a script and publishes the script to client 302.

Client 302 receives the script. The script includes custom action 326. Installer 306 populates registry 308 with data from the script to generate advertisement 310. Advertisement 310 is an indicator that a software product is ready for installation on client 302. Executor 312 may include an icon and/or a button that a user actuates to begin an install. In another aspect, executor 312 is a boot process that begins an install. In either situation, core installer 324 is installed to client 302 and custom action 326 associated with core installer 324 is executed.

Custom action 326 leverages privileges of core installer 324 to access satellite installers 328. As is more fully set forth below, custom action 326 includes code for identifying that a product includes multiple installers and that core installer 324 has been cached. Custom action 326 determines the product source and enumerates a list of satellite installers associated with product image 322. Satellite installers 328 are associated with client 302. Pre-generated scripts of satellite installers 328 are accessed and the scripts are applied to client 302 to facilitate satellite installer advertisement 310. To the end user, the installation process is seamless, as if, the product image includes a single installer.

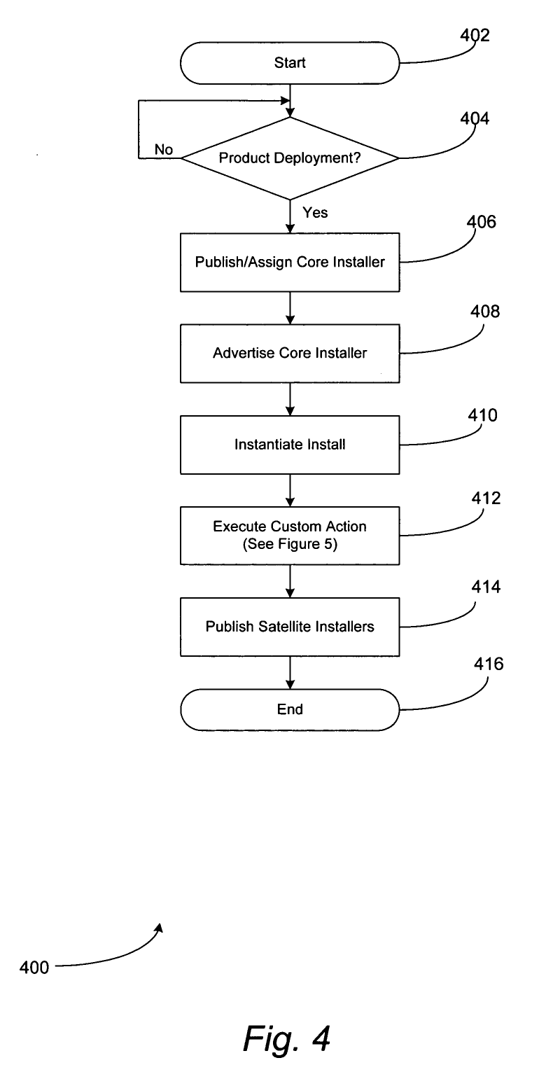

FIG. 4 represents an operational flow diagram for installing a multi-installer product. Operational flow 400 begins at start operation 402 and flows to decision operation 404. At decision operation 404 it is decided whether to issue a product deployment action. In one aspect, product deployment occurs when an administrator decides to distribute new and/or updated software products on a system of client devices. For example, a network administrator may decide to update client devices with MICROSOFT OFFICE 12. In one aspect, the product deployment is associated with a multi-installer software product.

Where product deployment is not desired, operational flow 400 loops back and waits for a product deployment action. Where product deployment is desired, operational flow 400 continues to operation 406. At operation 406, the core installer of a multi-installer software product is published/assigned. In one aspect, a software deployment technology such as MICROSOFT ACTIVE DIRECTORY publishes the core installer to a client. Although not necessary, operational flow 400 may continue to operation 408 where the core installer is advertised. The core installer is advertised when the software deployment technology publishes the core installer to the client. The advertisement may include an entry point where an install may be manually instantiated. In one respect the advertisement is not generated when the core installer is assigned to a client. When assigned, a boot process may automatically instantiate an install process.

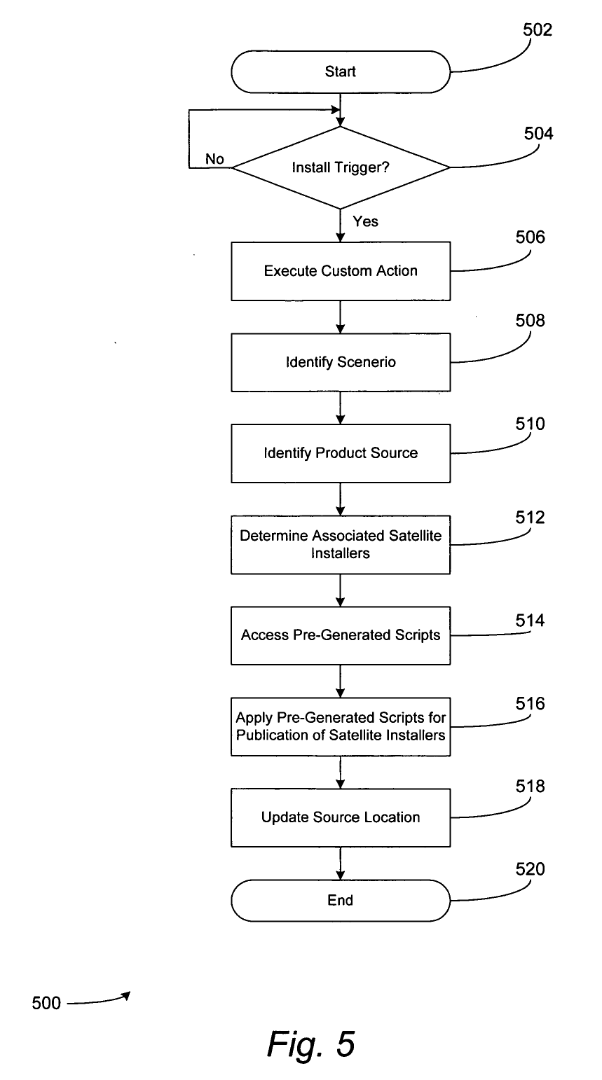

Operational flow 400 continues to operation 410. Operation 410 includes instantiating an install. As stated above an install may be instantiated by selecting an entry point or running a boot process. Operational flow 400 continues to operation 412 where the custom action is executed. The custom action is a program that is associated with the core installer that leverages the privileges of the core installer when published/assigned. The custom action leverages the privileges of the core installer to access and install satellite installers when the client device is in a lockdown mode. Operation 412 is more fully explained below in reference to FIG. 5.

Operational flow 400 continues to operation 414 where the satellite installers are published/assigned to the client device. To the end user, the function of the custom action creates an install process as if the software product included a single installer. The satellite installers may be installed by actuating an entry point or a boot process. Operational flow continues to end operation 416.

FIG. 5 represents an operational flow diagram for executing a custom action. Operational flow 500 begins at start operation 502 and continues to decision operation 504. At decision operation 504, it is decided whether an install trigger has been actuated. As previously stated, an install trigger may be actuated by a user actuating an entry point. An install trigger may also be actuated by a boot operation. When an install trigger is actuated, operational flow 500 continues to operation 506. The custom action that is associated with the core installer is actuated when the install trigger is actuated.

In executing the custom action, operational flow 500 continues to operation 508 where the scenario is identified. The custom action includes code to identify that the core installer has been cached. The custom action also includes code to identify that more installers are needed for a complete installation. When the scenario is identified, operational flow 500 continues to operation 510.

At operation 510, the software product source is identified. The custom action includes code to determine the source of the core installer. In finding the source, the custom action may associate an address with a location and/or find the source via an identifier. Operational flow 500 continues to operation 512 where the associated satellite installers are determined. When returning to the source, the custom action scans the source to determine if satellite installers are associated with the core installer. In determining associated satellite installers a list of satellite installers that are associated with the core installer may be generated.

Operational flow 500 continues to operation 514 where pre-generated scripts associated with the satellite installers are accessed. The satellite installers may include scripts that are pre-generated and coded into the satellite installers. The pre-generated scripts may include a set of default values. Operational flow 500 continues to operation 516 where the pre-generated scripts are applied to the client for publication/assignment to the client device. At operation 518 the source location is updated. In that the satellite installers include default values, after the scripts are applied, the actual values are accessed. Metadata associated with the satellite installers is also cleaned so that the satellite installers identify the same location as the core installer.

In this manner, the custom action associated with the core installer leverages the privileges of the core installer to install satellite installers on a lockdown client device. The custom action allows multi-installer software products to be installed on a client via a software deployment technology configured for single installer software products. In this manner, multi-installer software products may be easily deployed and installed on client devices.

Referring to FIG. 1, an exemplary system for implementing the invention includes a computing device, such as computing device 100. In a basic configuration, computing device 100 may include any type of stationary computing device or a mobile computing device. Computing device 100 typically includes at least one processing unit 102 and system memory 104. Depending on the exact configuration and type of computing device, system memory 104 may be volatile (such as RAM), non-volatile (such as ROM, flash memory, and the like) or some combination of the two. System memory 104 typically includes operating system 105, one or more applications 106, and may include program data 107. In one embodiment, applications 106 further include application 120 for multi-installer product deployment. This basic configuration is illustrated in FIG. 1 by those components within dashed line 108.

Computing device 100 may also have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and non-volatile, removable and non-removable media implemented in any method or technology for storage of information, such as computer readable instructions, data structures, program modules or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as a keyboard, mouse, pen, voice input device, touch input device, etc. Output device(s) 114 such as a display, speakers, printer, etc. may also be included.

Computing device 100 also contains communication connection(s) 116 that allow the device to communicate with other computing devices 118, such as over a network or a wireless network. Communication connection(s) 116 is an example of communication media. Communication media typically embodies computer readable instructions, data structures, program modules or other data in a modulated data signal such as a carrier wave or other transport mechanism and includes any information delivery media. The term “modulated data signal” may include a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. The term computer readable media as used herein includes both storage media and communication media.

Although the invention has been described in language that is specific to structural features and/or methodological steps, it is to be understood that the invention defined in the appended claims is not necessarily limited to the specific features or steps described. Rather, the specific features and steps are disclosed as forms of implementing the claimed invention. Since many embodiments of the invention can be made without departing from the spirit and scope of the invention, the invention resides in the claims hereinafter appended.

What is claimed is:

1. A computer-implemented method for installing a multi-installer program with single installer deployment, the method comprising:
associating a custom action with a core installer of a program;
instantiating an installation of the core installer, wherein the custom action is executed during the installation of the core installer; and
leveraging privileges of the core installer to facilitate access to satellite installers identified by the custom action.

2. The computer-implemented method of claim 1, wherein the program is a software program having multiple installers.

3. The computer-implemented method of claim 2, wherein the core installer includes application binaries and the satellite installers include resource strings.

4. The computer-implemented method of claim 1, wherein instantiating the installation includes a boot process.

5. The computer-implemented method of claim 1, wherein instantiating the installation includes advertising the core installer and activating an entry point associated with the advertising.

6. The computer-implemented method of claim 1, wherein the custom action is configured to identify a source of the core installer.

7. The computer-implemented method of claim 6, wherein the custom action is configured to leverage the privileges of the core installer to scan the source.

8. The computer-implemented method of claim 1, wherein the custom action is configured to identify a satellite installer associated with the core installer.

9. The computer-implemented method of claim 1, wherein the custom action is configured to access scripts associated with the satellite installers.

10. The computer-implemented method of claim 9, wherein the scripts are preconfigured and embedded in the satellite installers.

11. The computer-implemented method of claim 9, wherein the scripts are advertised.

12. A computer-readable medium having computer-executable instructions for accessing satellite installer during installation of a core installer, the instructions comprising:
determining the association of satellite installers during the installation of the core installer;
identifying a source of the core installer;
scanning the source;
identifying satellite installers associated with the core installer;
accessing pre-generated scripts associated with the satellite installers;
advertising the pre-generated scripts of the satellite installers.

13. The computer-readable medium of claim 12, wherein determining the association of satellite installers is facilitated by a custom action associated with the core installer.

14. The computer-readable medium of claim 12, wherein the pre-generated scripts include default values.

15. The computer-readable medium of claim 14, further comprising accessing actual values for the pre-generated scripts and replacing the default values with the actual values.

16. A computer-implemented method for leveraging privileges of a core installer to access satellite installers, the method comprising:
associating a custom action with a core installer of a multi-installer program;
instantiating the installation of the core installer;
executing the custom action of the core installer when installation is instantiated, wherein the custom action is configured to:
identify a source of the core installer;
leverage privileges of the core installer to scan the source;
identify satellite installers associated with the core installer;
access scripts associated with the satellite installers; and
advertise the scripts associated with the satellite installers.

17. The computer-implemented method of claim 16, further comprising deploying the core installer with a single installer deployment module.

18. The computer-implemented method of claim 16, wherein the core installer includes application binaries and the satellite installers include resource strings.

19. The computer-implemented method of claim 16, wherein instantiating the installation includes a boot process.

20. The computer-implemented method of claim 16, wherein instantiating the installation includes advertising the core installer and activating an entry point associated with the advertising.
